(19) United States
(12) Patent Application Publication
(10) Pub. No.: US 2026/0161200 A1
(43) Pub. Date: Jun. 11, 2026

(54) DISPLAY DEVICE AND FOLDABLE ELECTRONIC DEVICE INCLUDING THE SAME

(71) Applicant: Samsung Display Co., Ltd., Yongin-Si (KR)

(72) Inventors: Min Sung KIM, Yongin-si (KR); Sung Sang AHN, Yongin-si (KR); Min Hyuck KANG, Yongin-si (KR)

(21) Appl. No.: 19/253,963

(22) Filed: Jun. 30, 2025

(30) Foreign Application Priority Data
Dec. 9, 2024 (KR) 10-2024-0182057

(51) Int. Cl. G06F 1/16

(52) U.S. Cl. CPC G06F 1/1681; G06F 1/1641; G06F 1/1656

(57) ABSTRACT

Provided are a display device and a foldable electronic device including the same. The display device includes a display panel, and a panel support member disposed on the display panel and including a folding portion and a non-folding portion disposed on at least one side of the folding portion. The folding portion includes a plurality of slits penetrating through the panel support member and a plurality of bars disposed alternately with the plurality of slits. The panel support member further includes a plating layer covering at least a portion of the folding portion and including a metal material, and the plating layer is disposed on inner side surfaces of the plurality of slits.

### CROSS-REFERENCE TO RELATED APPLICATION

This application claims priority from Korean Patent Application No. 10-2024-0182057 filed on Dec. 9, 2024 in the Korean Intellectual Property Office, and all the benefits accruing therefrom under 35 U.S.C. 119, the contents of which in its entirety are herein incorporated by reference.

### BACKGROUND

### 1. Technical Field

The present disclosure relates to a display device and a foldable electronic device including the same.

### 2. Description of the Related Art

As the information society develops, the demand for display devices for displaying images has increased and diversified. The display devices may be liquid crystal displays (LCDs), field emission displays (FEDs), or light emitting displays (LEDs). The light emitting display may include an organic light emitting display including organic light emitting diode elements as light emitting elements, an inorganic light emitting display including inorganic light emitting diode elements as light emitting elements, or the like.

Recently, in order to increase portability of the display devices and provide wide display screens, bendable display devices in which a display area is bendable or foldable display devices in which a display area is foldable have been released.

### SUMMARY

Aspects of the present disclosure provide a display device having improved impact resistance, and a foldable electronic device including the same.

However, aspects of the present disclosure are not restricted to those set forth herein. The above and other aspects of the present disclosure will become more apparent to one of ordinary skill in the art to which the present disclosure pertains by referencing the detailed description of the present disclosure given below.

According to an aspect of the present disclosure, there is provided a display device including a display panel, and a panel support member disposed on the display panel and including a folding portion and a non-folding portion disposed on at least one side of the folding portion. The folding portion includes a plurality of slits penetrating through the panel support member and a plurality of bars disposed alternately with the plurality of slits. The panel support member further includes a plating layer covering at least a portion of the folding portion and including a metal material, and the plating layer is disposed on inner side surfaces of the plurality of slits.

In an embodiment, the metal material of the plating layer includes at least one of nickel, chromium, copper, zinc, gold, silver, palladium, tin, aluminum, iron, cobalt, and alloys thereof.

In an embodiment, a width of a slit of the plurality of slits is greater than or equal to a thickness of the panel support member excluding the plating layer.

In an embodiment, the plating layer includes a first side surface plating layer disposed on one side of a slit of the plurality of slits and a second side surface plating layer disposed on another side of the slit. The panel support member includes an opening disposed in a space between the first side surface plating layer and the second side surface plating layer, and a width of the opening is smaller than a width of the slit.

In an embodiment, the width of the opening is 50 μm or less.

In an embodiment, a thickness of the plating layer is smaller than half a thickness of the panel support member excluding the plating layer.

In an embodiment, the thickness of the plating layer is 40 μm or less.

In an embodiment, the plating layer is further disposed on at least one of an upper surface and a lower surface of the panel support member.

In an embodiment, the plating layer includes side surface plating layers disposed on inner side surfaces of the plurality of slits. The plating layer further includes at least one of an upper surface plating layer disposed on the upper surface of the panel support member and a lower surface plating layer disposed on the lower surface of the panel support member.

In an embodiment, the upper surface plating layer is disposed on the folding portion and is not disposed on the non-folding portion.

In an embodiment, the panel support member includes a metal plate or a fiber polymer.

According to an aspect of the present disclosure, there is provided a display device including a display panel, and a panel support member disposed on the display panel and including a folding portion and a non-folding portion disposed on at least one side of the folding portion. The folding portion includes a plurality of slits penetrating through the panel support member and a plurality of bars disposed alternately with the plurality of slits. The panel support member further includes a plating layer covering at least a portion of the folding portion, and the plating layer includes side surface plating layers disposed on inner side surfaces of the plurality of slits.

In an embodiment, the plating layer further includes an upper surface plating layer disposed on an upper surface of the panel support member and a lower surface plating layer disposed on a lower surface of the panel support member. Each of the upper surface plating layer and the lower surface plating layer is disposed on the plurality of bars.

In an embodiment, the upper surface plating layer and the lower surface plating layer are not disposed on the non-folding portion.

In an embodiment, a thickness of the panel support member in an area overlapping the folding portion is greater than a thickness of the panel support member in an area overlapping the non-folding portion.

In an embodiment, at least one of the upper surface plating layer and the lower surface plating layer is further disposed on the non-folding portion.

In an embodiment, a thickness of the plating layer is smaller than half a thickness of the panel support member excluding the plating layer.

In an embodiment, the plating layer includes a metal material.

In an embodiment, the panel support member includes a metal plate or a fiber polymer.

According to an aspect of the present disclosure, there is provided a foldable electronic device including a display device. The display device includes a display panel, a window member disposed above the display panel, an upper protection member disposed on the window member, a cover window disposed on the upper protection member, a panel protection member disposed below the display panel, and a panel support member disposed below the panel protection member and including a folding portion and a non-folding portion disposed on at least one side of the folding portion. The folding portion includes a plurality of slits penetrating through the panel support member and a plurality of bars disposed alternately with the plurality of slits. The panel support member further includes a plating layer covering at least a portion of the folding portion and including a metal material, and the plating layer is disposed on inner side surfaces of the plurality of slits.

With a display device and a foldable electronic device including the same according to an embodiment of the present disclosure, impact resistance may be improved.

The effects of the present disclosure are not limited to the aforementioned effects, and various other effects are included in the present specification.

### BRIEF DESCRIPTION OF THE DRAWINGS

The above and other aspects and features of the present disclosure will become more apparent by describing in detail embodiments thereof with reference to the attached drawings.

FIG. 1 is a perspective view illustrating an unfolded state of a display device according to an embodiment.

FIG. 2 is a perspective view illustrating a folded state of the display device according to an embodiment.

FIG. 3 is a perspective view illustrating an unfolded state of a display device according to an embodiment.

FIG. 4 is a perspective view illustrating a folded state of the display device according to an embodiment.

FIG. 5 is an exploded perspective view illustrating the display device according to an embodiment.

FIG. 6 is a cross-sectional view taken along line X1-X1′ of FIG. 5.

FIG. 7 is a cross-sectional view illustrating an example of a display panel according to an embodiment.

FIG. 8 is a plan view illustrating a panel support member according to an embodiment.

FIG. 9 is an enlarged view of area A of FIG. 8.

FIG. 10 is a cross-sectional view taken along line X2-X2′ of FIG. 8.

FIG. 11 is a cross-sectional view illustrating an impact resistance test of the display device according to an embodiment.

FIG. 12 is a cross-sectional view illustrating an impact resistance test of a display device according to a comparative example.

FIG. 13 is a cross-sectional view illustrating a panel support member according to an embodiment.

FIG. 14 is a cross-sectional view illustrating a panel support member according to an embodiment.

FIG. 15 is a cross-sectional view illustrating a panel support member according to an embodiment.

FIG. 16 is a cross-sectional view illustrating a panel support member according to an embodiment.

### DETAILED DESCRIPTION OF THE EMBODIMENTS

The inventive concept will now be described more fully hereinafter with reference to the accompanying drawings, in which embodiments of the inventive concept are shown. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

It will also be understood that when a layer is referred to as being “on” another layer or substrate, it can be directly on the other layer or substrate, or intervening layers may also be present. The same reference numbers indicate the same components throughout the specification.

Hereinafter, embodiments of the present disclosure will be described in detail with reference to the accompanying drawings.

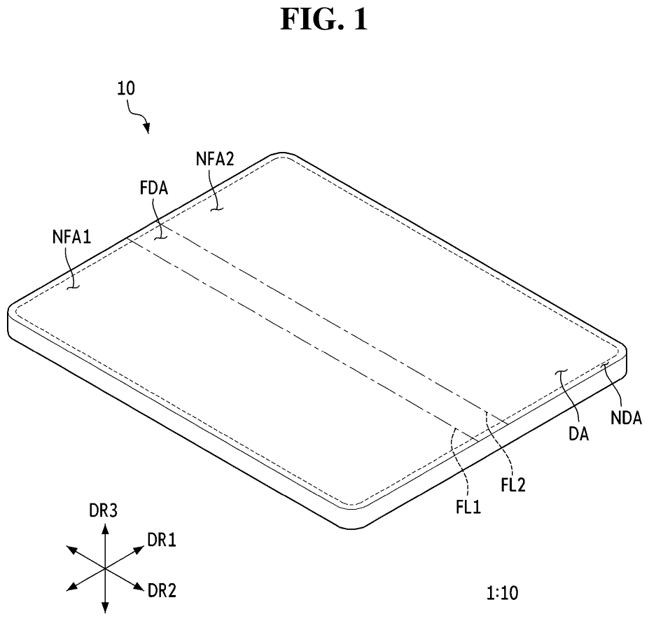

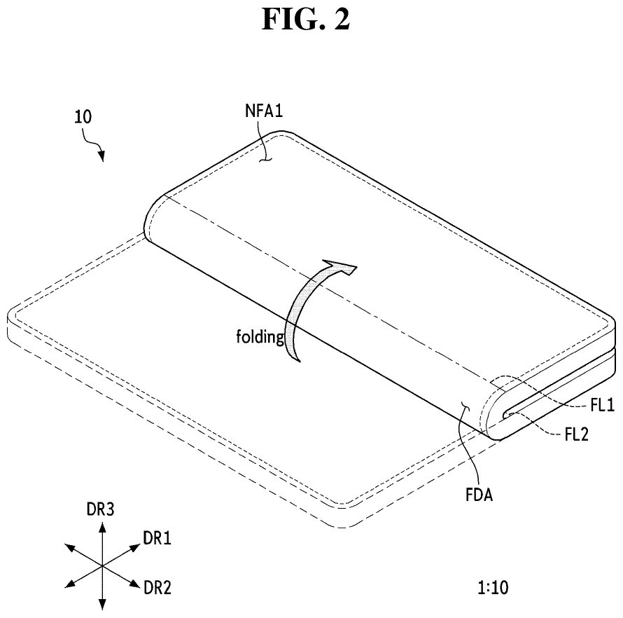

FIG. 1 is a perspective view illustrating an unfolded state of a display device 10 according to an embodiment. FIG. 2 is a perspective view illustrating a folded state of the display device 10 according to an embodiment.

Referring to FIGS. 1 and 2, an electronic device 1 displays a moving image or a still image. The electronic device 1 may refer to all electronic devices that provide display screens. For example, televisions, laptop computers, monitors, billboards, the Internet of Things (IoT), mobile phones, smartphones, tablet personal computers (PCs), electronic watches, smart watches, watch phones, head mounted displays, mobile communication terminals, electronic notebooks, electronic books, portable multimedia players (PMPs), navigation devices, game machines, digital cameras, camcorders, and the like, that provide display screens, may be included in the electronic device 1.

The electronic device 1 may include the display device 10 providing a display screen. The display device 10 is a device that displays a moving image or a still image. Examples of the display device may include an inorganic light emitting diode display, an organic light emitting display, a quantum dot light emitting display, a plasma display, a field emission display, and the like. Hereinafter, a case where an organic light emitting diode display is applied as an example of the display device will be described by way of example, but the present disclosure is not limited thereto, and the same technical spirit may be applied to other display devices if applicable.

A first state of a display device 10 that is not folded at folding lines FL1 and FL2 and is unfolded is illustrated in FIG. 1, and a second state of the display device 10 that is folded at the folding lines FL1 and FL2 is illustrated in FIG. 2.

The display device 10 may have a quadrangular shape such as a rectangular shape in plan view. Each of corners of the display device 10 may have a right-angled shape in plan view or a round shape in plan view. A front surface of the display device 10 may include two short sides disposed in a first direction DR1 and two long sides disposed in a second direction DR2.

In the drawings, the first direction DR1 and the second direction DR2 are horizontal directions, respectively, and cross each other. For example, the first direction DR1 and the second direction DR2 may be orthogonal to each other. In addition, a third direction DR3 may be a perpendicular direction crossing, for example, orthogonal to, the first direction DR1 and the second direction DR2. Unless otherwise defined, directions indicated by arrows of the first to third directions DR1, DR2, and DR3 may be referred to as one side, and directions opposite to one side may be referred to as the other side. In addition, the terms “on”, “upper side”, “upper portion”, “top, and “upper surface” as used herein refer to a direction toward which an arrow of the third direction DR3 is directed in the drawings, and the terms “below”, “lower side”, “lower portion”, “bottom, and “lower surface” used as herein refer to a direction opposite to the direction toward which the arrow of the third direction DR3 is directed in the drawings.

The display device 10 may include a display area DA and a non-display area NDA. A shape of the display area DA in plan view may follow the shape of the display device 10 in plan view. For example, when the shape of the display device 10 in plan view is the rectangular shape, the shape of the display area DA in plan view may also be a rectangular shape.

The display area DA may be an area displaying an image by including a plurality of pixels. The non-display area NDA may be an area that does not display an image because it does not include pixels. The non-display area NDA may be disposed around the display area DA. The non-display area NDA may be disposed to surround the display area DA, but an embodiment of the present disclosure is not limited thereto. The display area DA may be partially surrounded by the non-display area NDA.

The display device 10 may be maintained in both a first state, which is an unfolded state, and a second state, which is a folded state. In an embodiment, the display device 10 may be folded in an in-folding manner in which the display areas DA face each other as illustrated in FIG. 2. In this case, front surfaces of the display device 10 may face each other when the display device 10 is folded. In an embodiment, the display device 10 may be folded in an out-folding manner so that rear surfaces thereof face each other.

The display device 10 may include a folding area FDA, a first non-folding area NFA1, and a second non-folding area NFA2. The folding area FDA may be an area where the display device 10 is bent or folded, and the first non-folding area NFA1 and the second non-folding area NFA2 may be areas where the display device 10 is not bent or folded. In an embodiment, the first non-folding area NFA1 and the second non-folding area NFA2 may be flat areas of the display device 10.

The first non-folding area NFA1 may be disposed on one side, for example, the left side, of the folding area FDA. The second non-folding area NFA2 may be disposed on the other side, for example, the right side, of the folding area FDA. The folding area FDA is an area defined by the first folding line FL1 and the second folding line FL2, and may be an area where the display device 10 is bent with a predetermined curvature. The first folding line FL1 may be a boundary between the folding area FDA and the first non-folding area NFA1, and the second folding line FL2 may be a boundary between the folding area FDA and the second non-folding area NFA2.

The first folding line FL1 and the second folding line FL2 may extend in the second direction DR2 as illustrated in FIGS. 1 and 2, and in this case, the display device 10 may be folded based on the second direction DR2. For this reason, a length of the display device 10 in the first direction DR1 may be reduced by approximately half, and thus, a user may conveniently carry the display device 10.

The first non-folding area NFA1 may be disposed on one side, for example, the left side, of the folding area FDA. The second non-folding area NFA2 may be disposed on the other side, for example, the right side, of the folding area FDA. Here, the left side may refer to one side in the first direction DR1, and the right side may refer to the other side in the first direction DR1.

When the first folding line FL1 and the second folding line FL2 extend in the second direction DR2 as illustrated in FIGS. 1 and 2, a length of the folding area FDA in the second direction DR2 may be greater than a length of the folding area FDA in the first direction DR1. In addition, a length of the first non-folding area NFA1 in the second direction DR2 may be greater than a length of the first non-folding area NFA1 in the first direction DR1. A length of the second non-folding area NFA2 in the second direction DR2 may be greater than a length of the second non-folding area NFA2 in the first direction DR1.

Each of the display area DA and the non-display area NDA may overlap at least one of the folding area FDA, the first non-folding area NFA1, and the second non-folding area NFA2. It is illustrated in FIGS. 1 and 2 that each of the display area DA and the non-display area NDA overlaps the folding area FDA, the first non-folding area NFA1, and the second non-folding area NFA2.

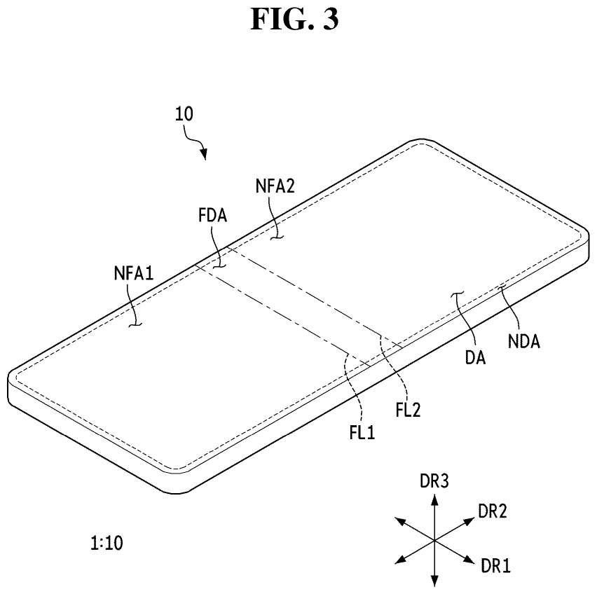

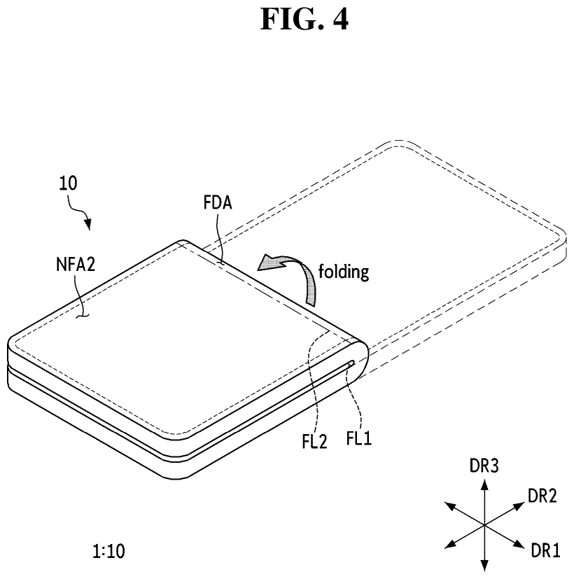

FIG. 3 is a perspective view illustrating an unfolded state of a display device 10 according to an embodiment. FIG. 4 is a perspective view illustrating a folded state of the display device 10 according to an embodiment.

Referring to FIGS. 3 and 4 in addition to FIGS. 1 and 2, a first state of a display device 10 that is not folded at folding lines FL1 and FL2 and is unfolded is illustrated in FIG. 3, and a second state of the display device 10 that is folded at the folding lines FL1 and FL2 is illustrated in FIG. 4.

An embodiment of FIGS. 3 and 4 is different from an embodiment of FIGS. 1 and 2 in that the first folding line FL1 and the second folding line FL2 extend in the first direction DR1, and the display device 10 is folded in the second direction DR2, and thus, a length of the display device 10 in the second direction DR2 is reduced by approximately half. Therefore, in FIGS. 3 and 4, a description of contents overlapping those of an embodiment of FIGS. 1 and 2 will be omitted.

In the first state in which the display device 10 is unfolded, long sides of the display device 10 may extend along the second direction DR2, and short sides of the display device 10 may extend along the first direction DR1.

The first folding line FL1 and the second folding line FL2 may extend in the first direction DR1 as illustrated in FIGS. 3 and 4, and in this case, the display device 10 may be folded based on the first direction DR1.

The first non-folding area NFA1 may be disposed on one side, for example, the lower side, of the folding area FDA. The second non-folding area NFA2 may be disposed on the other side, for example, the upper side, of the folding area FDA. Here, the upper side may refer to one side in the second direction DR2, and the lower side may refer to the other side in the second direction DR2.

When the first folding line FL1 and the second folding line FL2 extend in the first direction DR1 as illustrated in FIGS. 3 and 4, a length of the folding area FDA in the first direction DR1 may be greater than a length of the folding area FDA in the second direction DR2. In addition, a length of the first non-folding area NFA1 in the second direction DR2 may be greater than a length of the first non-folding area NFA1 in the first direction DR1. A length of the second non-folding area NFA2 in the second direction DR2 may be greater than a length of the second non-folding area NFA2 in the first direction DR1.

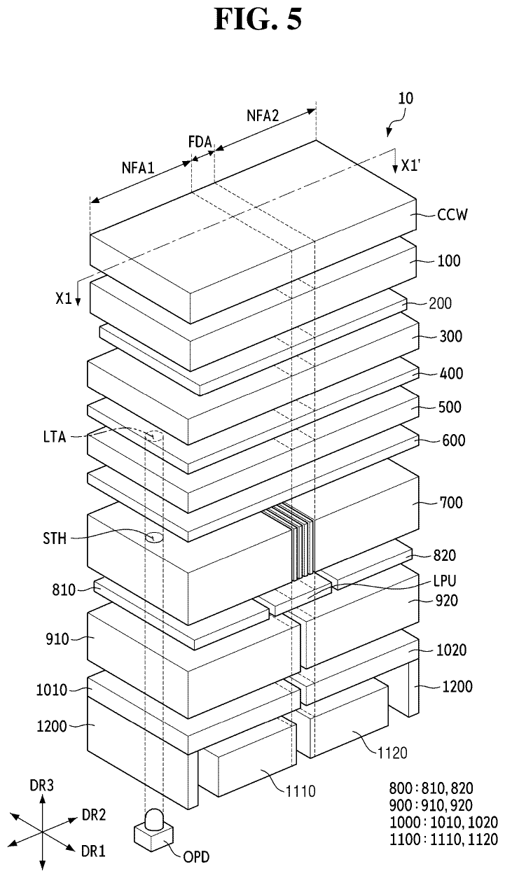

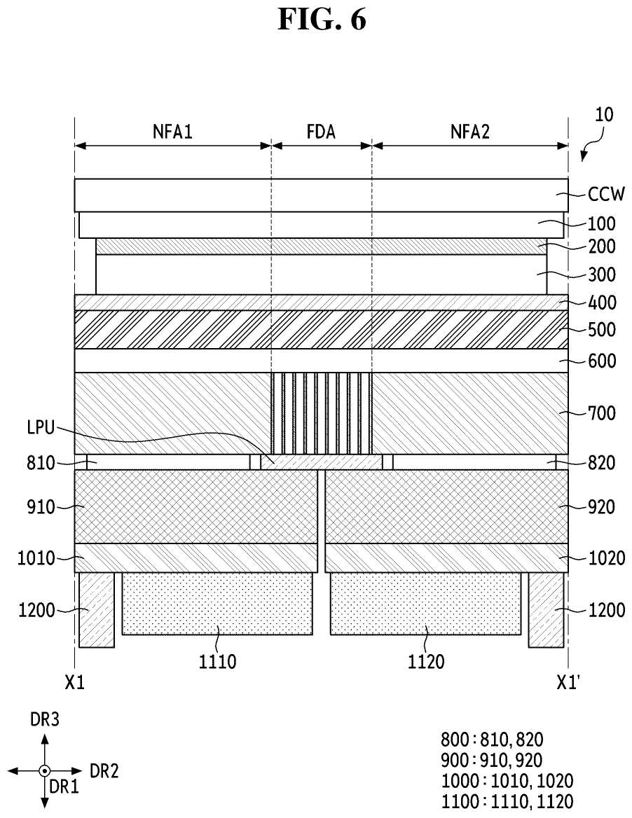

FIG. 5 is an exploded perspective view illustrating the display device 10 according to an embodiment. FIG. 6 is a cross-sectional view taken along line X1-X1′ of FIG. 5.

Referring to FIGS. 5 and 6, the display device 10 according to an embodiment may include a cover window CCW, an upper protection member 100, a window member 200, a first adhesive member 300, a display panel 400, a panel protection member 500, a panel lower member 600, a panel support member 700, a second adhesive member 800, a lower viewing prevention member LPU, a digitizer member 900, a metal support member 1000, a buffer member 1100, and a third adhesive member 1200.

The display panel 400 may be a panel that displays an image. The display panel 400 may be an organic light emitting display panel including organic light emitting layers, a quantum dot light emitting display panel including quantum dot light emitting layers, an inorganic light emitting display panel using inorganic semiconductor elements as light emitting elements, and a micro light emitting display panel using micro light emitting diodes as light emitting elements. Hereinafter, it will be mainly described that the display panel 400 is an organic light emitting display panel, but the present disclosure is not limited thereto.

The display panel 400 may include a light transmission area LTA overlapping an optical device OPD in the third direction DR3. The optical device OPD is an optical sensor that senses light, and may be, for example, a camera sensor, a proximity sensor, and an illuminance sensor. The light transmission area LTA may be a portion of the display area DA.

The light transmission area LTA may include a transmission area capable of transmitting light therethrough. In an embodiment, the light transmission area LTA may be a through hole penetrating through the display panel. Light transmittance of the light transmission area LTA may be higher than light transmittance of the display area DA excluding the light transmission area LTA. In addition, due to the transmission area of the light transmission area LTA, a density or a degree of integration of pixels in the light transmission area LTA may be lower than a density or a degree of integration of pixels in the display area DA excluding the light transmission area LTA. For example, the number of pixels per unit area in the light transmission area LTA may be smaller than the number of pixels per unit area in the display area DA excluding the light transmission area LTA. In an embodiment, pixels per inch (PPI) in the light transmission area LTA may be smaller than PPI in the display area DA excluding the light transmission area LTA.

The window member 200 may be attached to a front surface of the display panel 400 by the first adhesive member 300. The window member 200 may be made of a transparent material such as glass or plastic. For example, the window member 200 may be an ultra thin glass (UTG) having a thickness of 0.1 mm or less or a transparent polyimide film.

The first adhesive member 300 may be disposed on a rear surface of the window member 200. For example, the first adhesive member 300 may be disposed between the window member 200 and the display panel 400. The window member 200 and the display panel 400 may be bonded to each other through the first adhesive member 300. The first adhesive member 300 may include a transparent adhesive such as a pressure sensitive adhesive (PSA) or an optically clear adhesive (OCA). The first adhesive member 300 may include an acrylic adhesive material.

The upper protection member 100 may be disposed on a front surface of the window member 200. The upper protection member 100 may be attached to the front surface of the window member 200. The upper protection member 100 may perform at least one of an anti-scattering function of the window member 200, an impact absorption function, an anti-scratch function, an anti-fingerprint function, and an anti-glare function.

In some embodiments, a light blocking pattern may be formed on a rear surface of the upper protection member 100. The light blocking pattern may be disposed at an edge of the upper protection member 100 or be disposed adjacent to the edge of the upper protection member 100. The light blocking pattern may include a light blocking material capable of blocking light. For example, the light blocking pattern may be made of an inorganic black pigment such as carbon black, an organic black pigment, or an opaque metal material.

The cover window CCW may be disposed on the upper protection member 100. The cover window CCW may be a protective film for protecting the display device 10 from external impact. The cover window CCW may be attached to the display device 10 through an adhesive member or removed from the display device 10. That is, the cover window CCW may be a changeable window. In an embodiment, the cover window CCW may include at least one of flexible polyethylene terephthalate (PET) and thermoplastic polyurethane (TPU), but is not limited thereto.

The panel protection member 500 may be disposed on a rear surface of the display panel 400. The panel protection member 500 may serve to support the display panel 400 and protect the rear surface of the display panel 400. The panel protection member 500 may be made of plastic such as polyethylene terephthalate (PET) or polyimide. It is illustrated in FIGS. 5 and 6 that the panel protection member 500 is also disposed in the folding area FDA of the display device 10, but an embodiment of the present disclosure is not limited thereto. For example, the panel protection member 500 may be removed in the folding area FDA of the display device 10 in order for the display device 10 to be smoothly folded.

The panel lower member 600 may be disposed on a rear surface of the panel protection member 500. The panel lower member 600 may include at least one of a light blocking layer for absorbing light incident from the outside, a buffer layer for absorbing external impact, and a heat dissipation layer for efficiently dissipating heat of the display panel 400.

The light blocking layer blocks transmission of the light to prevent components such as the digitizer member 900 and the like disposed below the light blocking layer from being viewed from above the display panel 400. The light blocking layer may include a light absorbing material such as a black pigment or a black dye.

The buffer layer absorbs the external impact to prevent the display panel 400 from being damaged. The buffer layer may be formed as a single layer or a plurality of layers. For example, the buffer layer may be made of a polymer resin such as polyurethane, polycarbonate, polypropylene, or polyethylene or may include a material having elasticity, such as a sponge formed by foaming rubber, a urethane-based material, or an acrylic material.

The heat dissipation layer may include a first heat dissipation layer including graphite, carbon nanotubes, or the like, and a second heat dissipation layer formed as a thin metal film such as copper, nickel, ferrite, or silver that may shield electromagnetic waves and has excellent thermal conductivity.

In some embodiments, the panel lower member 600 may be omitted.

The panel support member 700 may be disposed on a rear surface of the panel lower member 600. The panel support member 700 may be a rigid member whose shape or volume does not change easily due to an external pressure. Since the panel support member 700 is disposed on the rear surface of the display panel 400 and is the rigid member whose shape or volume does not change easily due to the external pressure, the panel support member 700 may support the display panel 400.

In an embodiment, the panel support member 700 may be made of a polymer including carbon fiber or glass fiber. In this case, since the panel support member 700 is made of the polymer including the carbon fiber or the glass fiber, the panel support member 700 may pass magnetic fields or electromagnetic signals of the digitizer member 900 therethrough. Therefore, the panel support member 700 capable of supporting the display panel 400 without lowering touch sensitivity of the digitizer member 900 may be provided.

In an embodiment, the panel support member 700 may be a metal plate. For example, the panel support member 700 is a metal plate, and may be made of a metal or a metal alloy. The panel support member 700 may include copper (Cu), aluminum (Al), stainless steel (SUS), and/or alloys thereof, but is not limited thereto.

The panel support member 700 may include a through hole STH overlapping the optical device OPD in the third direction DR3. The through hole STH may overlap the light transmission area LTA of the display panel 400 in the third direction DR3. An area of the through hole STH may be greater than an area of the light transmission area LTA. The optical device OPD may sense light incident from a front surface of the display device 10 through the light transmission area LTA and the through hole STH.

The panel support member 700 may include a grating pattern disposed in the folding area FDA so as to be easily bent in the folding area FDA. The panel support member 700 may include the grating pattern disposed in the folding area FDA, and may thus be easily bent when the display device 10 is folded.

The lower viewing prevention member LPU may be disposed on a rear surface of the panel support member 700. The lower viewing prevention member LPU may be disposed to overlap the folding area FDA. The lower viewing prevention member LPU may be disposed at the same layer as the second adhesive member 800. The lower viewing prevention member LPU may be disposed between a second-first adhesive member 810 and a second-second adhesive member 820. The lower viewing prevention member LPU may prevent the grating pattern of the panel support member 700 from being viewed to the outside. The lower viewing prevention member LPU may include a flexible material to reduce folding stress of the display device 10.

The second adhesive member 800 may be disposed on a front surface of the digitizer member 900. For example, the second adhesive member 800 may be disposed between the panel support member 700 and the digitizer member 900. The panel support member 700 and the digitizer member 900 may be bonded to each other through the second adhesive member 800. The second adhesive member 800 may include a transparent adhesive such as a pressure sensitive adhesive (PSA) or an optically clear adhesive (OCA). The second adhesive member 800 may include an acrylic adhesive material.

In some embodiments, the second adhesive member 800 may include the second-first adhesive member 810 overlapping a first digitizer member 910 and the second-second adhesive member 820 overlapping a second digitizer member 920. The second-first adhesive member 810 and the second-second adhesive member 820 may be disposed to be spaced apart from each other with the lower viewing prevention member LPU interposed therebetween.

The digitizer member 900 may include the first digitizer member 910 and the second digitizer member 920. The first digitizer member 910 and the second digitizer member 920 may be disposed on the rear surface of the panel support member 700. The first digitizer member 910 and the second digitizer member 920 may be attached to the rear surface of the panel support member 700 by the second adhesive member 800.

The first digitizer member 910 and the second digitizer member 920 may not be disposed in the folding area FDA in order to reduce the folding stress of the display device 10. The first digitizer member 910 may be disposed in the first non-folding area NFA1, and the second digitizer member 920 may be disposed in the second non-folding area NFA2. A gap between the first digitizer member 910 and the second digitizer member 920 may overlap the folding area FDA, and may be smaller than a width of the folding area FDA. The width of the folding area FDA may be a length of the folding area FDA in the second direction DR2.

The first digitizer member 910 and the second digitizer member 920 may include electrode patterns for sensing approach or contact of an electronic pen such as a stylus pen supporting electromagnetic resonance (EMR). The first digitizer member 910 and the second digitizer member 920 may sense magnetic fields or electromagnetic signals emitted from the electronic pen based on the electrode patterns, and decide a point where the sensed magnetic field or electromagnetic signal is the greatest as a touch coordinate.

Magnetic metal powders may be disposed on a rear surface of the first digitizer member 910 and a rear surface of the second digitizer member 920. In this case, the magnetic fields or the electromagnetic signals passing through the first digitizer member 910 and the second digitizer member 920 may flow into the magnetic metal powders. Therefore, due to the magnetic metal powders, a phenomenon in which the magnetic fields or the electromagnetic signals of the first digitizer member 910 and the second digitizer member 920 are emitted to a rear surface of the display device 10 may be reduced.

The metal support member 1000 may include a first metal support member 1010 and a second metal support member 1020. The first metal support member 1010 may be disposed on the rear surface of the first digitizer member 910, and the second metal support member 1020 may be disposed on the rear surface of the second digitizer member 920.

The first metal support member 1010 and the second metal support member 1020 may not be disposed in the folding area FDA in order to reduce the folding stress of the display device 10. The first metal support member 1010 may be disposed in the first non-folding area NFA1, and the second metal support member 1020 may be disposed in the second non-folding area NFA2. A gap between the first metal support member 1010 and the second metal support member 1020 may overlap the folding area FDA, and may be smaller than the width of the folding area FDA.

The first metal support member 1010 and the second metal support member 1020 may include a material having high rigidity in order to support the first digitizer member 910 and the second digitizer member 920, respectively. For example, the first metal support member 1010 and the second metal support member 1020 may include stainless steel such as SUS316.

The buffer member 1100 may include a first buffer member 1110 and a second buffer member 1120. The first buffer member 1110 and the second buffer member 1120 may absorb external impact to prevent the panel support member 700 and the digitizer member 900 from being damaged. The first buffer member 1110 and the second buffer member 1120 may include a material having elasticity, such as a sponge formed by foaming rubber, a urethane-based material, or an acrylic material.

The first buffer member 1110 may be disposed on a rear surface of the first metal support member 1010, and the second buffer member 1120 may be disposed on a rear surface of the second metal support member 1020. The first buffer member 1110 and the second buffer member 1120 may not be disposed in the folding area FDA in order to reduce the folding stress of the display device 10. The first buffer member 1110 may be disposed in the first non-folding area NFA1, and the second buffer member 1120 may be disposed in the second non-folding area NFA2. A gap between the first buffer member 1110 and the second buffer member 1120 may overlap the folding area FDA, and may be smaller than the width of the folding area FDA.

The third adhesive member 1200 may be disposed on the rear surface of the first metal support member 1010 and the rear surface of the second metal support member 1020. The third adhesive member 1200 may be disposed at an edge of the first metal support member 1010 and an edge of the second metal support member 1020. It is illustrated in FIGS. 5 and 6 that the third adhesive members 1200 are disposed on both sides of the first buffer member 1110 and the second buffer member 1120, but the present disclosure is not limited thereto. For example, the third adhesive member 1200 may be disposed to surround the first buffer member 1110 and the second buffer member 1120.

The third adhesive member 1200 may be a waterproof tape or a waterproof member attaching the rear surface of the first metal support member 1010 to a front surface of a frame disposed on a rear surface of the buffer member 1100. For this reason, permeation of moisture or dust into the display device 10 may be prevented by the third adhesive member 1200. That is, the display device 10 capable of being waterproof and dustproof may be provided.

In an embodiment, the third adhesive member 1200 does not surround the first buffer member 1110 and the second buffer member 1120, and may be disposed to overlap a magnet for maintaining the folding of the display device 10 in the third direction DR3. In this case, the third adhesive member 1200 may serve as a magnetism shielding member capable of shielding magnetism of the magnet in order to prevent the digitizer member 900 or the display panel 400 from being affected by the magnetism.

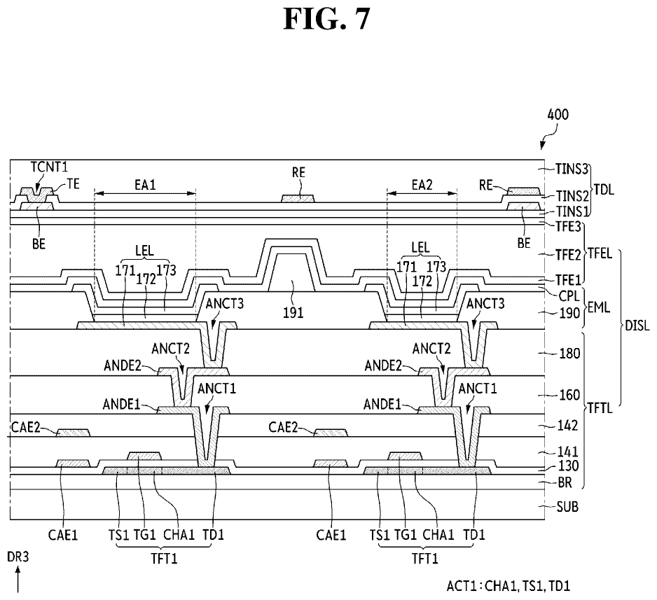

FIG. 7 is a cross-sectional view illustrating an example of a display panel 400 according to an embodiment.

Referring to FIG. 7, the display panel 400 may include a substrate SUB, a display layer DISL disposed on the substrate SUB, and a touch sensing layer TDL disposed on the display layer DISL. The display layer DISL may include a thin film transistor layer TFTL, a light emitting element layer EML, and an encapsulation layer TFEL.

The thin film transistor layer TFTL may be disposed on the substrate SUB. The thin film transistor layer TFTL may include a barrier film BR, thin film transistors TFT1, first capacitor electrodes CAE1, second capacitor electrodes CAE2, first anode connection electrodes ANDE1, second anode connection electrodes ANDE2, a gate insulating film 130, a first interlayer insulating film 141, a second interlayer insulating film 142, a first planarization film 160, and a second planarization film 180.

The substrate SUB may be made of an insulating material such as a polymer resin. For example, the substrate SUB may be made of polyimide. The substrate SUB may be a flexible substrate that may be bent, folded, and rolled.

The barrier film BR may be disposed on the substrate SUB. The barrier film BR is a film for protecting thin film transistors of the thin film transistor layer TFTL and light emitting layers 172 of the light emitting element layer EML from moisture permeating through the substrate SUB vulnerable to moisture permeation. The barrier film BR may include a plurality of inorganic films that are alternately stacked. For example, the barrier film BR may be formed as multiple films in which one or more inorganic films of a silicon nitride layer, a silicon oxynitride layer, a silicon oxide layer, a titanium oxide layer, and an aluminum oxide layer are alternately stacked.

The thin film transistors TFT1 may be disposed on the barrier film BR. Active layers ACT1 of the thin film transistors TFT1 may be disposed on the barrier film BR. The active layer ACT1 of the thin film transistor TFT1 may include polycrystalline silicon, single crystal silicon, low-temperature polycrystalline silicon, amorphous silicon, or an oxide semiconductor.

The active layer ACT1 may include a channel region CHA1, a source region TS1, and a drain region TD1. The channel region CHA1 may be a region overlapping a gate electrode TG1 in the third direction DR3, which is a thickness direction of the substrate SUB. The source region TS1 may be disposed on one side of the channel region CHA1, and the drain region TD1 may be disposed on the other side of the channel region CHA1. The source region TS1 and the drain region TD1 may be regions that do not overlap the gate electrode TG1 in the third direction DR3. The source region TS1 and the drain region TD1 may be regions having conductivity by doping a silicon semiconductor or an oxide semiconductor with ions or impurities.

The gate insulating film 130 may be disposed on the active layer ACT1 of the thin film transistor TFT1. The gate insulating film 130 may be formed as an inorganic film such as a silicon nitride layer, a silicon oxynitride layer, a silicon oxide layer, a titanium oxide layer, or an aluminum oxide layer.

The gate electrodes TG1 of the thin film transistors TFT1 and the first capacitor electrodes CAE1 may be disposed on the gate insulating film 130. The gate electrode TG1 may overlap the channel region CHA1 in the third direction DR3. It is illustrated in FIG. 7 that the gate electrode TG1 and the first capacitor electrode CAE1 are disposed to be spaced apart from each other, but the gate electrode TG1 and the first capacitor electrode CAE1 may also be connected to and formed integrally with each other. Each of the gate electrode TG1 and the first capacitor electrode CAE1 may be formed as a single layer or multiple layers made of any one of molybdenum (Mo), aluminum (Al), chromium (Cr), gold (Au), titanium (Ti), nickel (Ni), neodymium (Nd), and copper (Cu), or alloys thereof.

The first interlayer insulating film 141 may be disposed on the gate electrodes TG1 of the thin film transistors TFT1 and the first capacitor electrodes CAE1. The first interlayer insulating film 141 may be formed as an inorganic film such as a silicon nitride layer, a silicon oxynitride layer, a silicon oxide layer, a titanium oxide layer, or an aluminum oxide layer. The first interlayer insulating film 141 may be formed as a plurality of inorganic films.

The second capacitor electrodes CAE2 may be disposed on the first interlayer insulating film 141. The second capacitor electrode CAE2 may overlap the first capacitor electrode CAE1 in the third direction DR3. In addition, when the gate electrode TG1 and the first capacitor electrode CAE1 are formed integrally with each other, the second capacitor electrode CAE2 may overlap the gate electrode TG1 in the third direction DR3. Since the first interlayer insulating film 141 has a predetermined dielectric constant, a capacitor may be formed by the first capacitor electrode CAE1, the second capacitor electrode CAE2, and the first interlayer insulating film 141 disposed between the first capacitor electrode CAE1 and the second capacitor electrode CAE2. The second capacitor electrode CAE2 may be formed as a single layer or multiple layers made of any one of molybdenum (Mo), aluminum (Al), chromium (Cr), gold (Au), titanium (Ti), nickel (Ni), neodymium (Nd), and copper (Cu), or alloys thereof.

The second interlayer insulating film 142 may be disposed on the second capacitor electrodes CAE2. The second interlayer insulating film 142 may be formed as an inorganic film such as a silicon nitride layer, a silicon oxynitride layer, a silicon oxide layer, a titanium oxide layer, or an aluminum oxide layer. The second interlayer insulating film 142 may be formed as a plurality of inorganic films.

The first anode connection electrodes ANDE1 may be disposed on the second interlayer insulating film 142. The first anode connection electrode ANDE1 may be connected to the drain region TD1 of the thin film transistor TFT1 through a first connection contact hole ANCT1 penetrating through the gate insulating film 130, the first interlayer insulating film 141, and the second interlayer insulating film 142. The first anode connection electrode ANDE1 may be formed as a single layer or multiple layers made of any one of molybdenum (Mo), aluminum (Al), chromium (Cr), gold (Au), titanium (Ti), nickel (Ni), neodymium (Nd), and copper (Cu), or alloys thereof.

The first planarization film 160 for planarizing a step due to the thin film transistors TFT1 may be disposed on the first anode connection electrodes ANDE1. The first planarization film 160 may be formed as an organic film made of an acrylic resin, an epoxy resin, a phenolic resin, a polyamide resin, a polyimide resin, or the like.

The second anode connection electrodes ANDE2 may be disposed on the first planarization film 160. The second anode connection electrode ANDE2 may be connected to the first anode connection electrode ANDE1 through a second connection contact hole ANCT2 penetrating through the first planarization film 160. The second anode connection electrode ANDE2 may be formed as a single layer or multiple layers made of any one of molybdenum (Mo), aluminum (Al), chromium (Cr), gold (Au), titanium (Ti), nickel (Ni), neodymium (Nd), and copper (Cu), or alloys thereof.

The second planarization film 180 may be disposed on the second anode connection electrodes ANDE2. The second planarization film 180 may be formed as an organic film made of an acrylic resin, an epoxy resin, a phenolic resin, a polyamide resin, a polyimide resin, or the like.

The light emitting element layer EML including light emitting elements LEL and a bank 190 may be disposed on the second planarization film 180. Each of the light emitting elements LEL includes a pixel electrode 171, the light emitting layer 172, and a common electrode 173.

The pixel electrode 171 may be disposed on the second planarization film 180. The pixel electrode 171 may be connected to the second anode connection electrode ANDE2 through a third connection contact hole ANCT3 penetrating through the second planarization film 180.

In a top emission structure in which light is emitted toward the common electrode 173 based on the light emitting layer 172, the pixel electrode 171 may be made of a metal material having high reflectivity, such as a stacked structure (Ti/Al/Ti) of aluminum (Al) and titanium (Ti), a stacked structure (ITO/Al/ITO) of aluminum (Al) and indium tin oxide (ITO), a stacked structure (ITO/Ag/ITO) of silver (Ag) and ITO, an APC alloy, and a stacked structure (ITO/APC/ITO) of an APC alloy and ITO. The APC alloy is an alloy of silver (Ag), palladium (Pd), and copper (Cu).

The bank 190 may be formed to partition the pixel electrodes 171 on the second planarization film 180 in order to define light emitting portions EA1 and EA2. The bank 190 may be disposed to cover edges of the pixel electrode 171. The bank 190 may be formed as an organic film made of an acrylic resin, an epoxy resin, a phenolic resin, a polyamide resin, a polyimide resin, or the like.

Each of a first light emitting portion EA1 and a second light emitting portion EA2 refers to each area where the pixel electrode 171, the light emitting layer 172, and the common electrode 173 are sequentially stacked and holes from the pixel electrode 171 and electrons from the common electrode 173 are recombined with each other in the light emitting layer 172 to emit light.

The light emitting layer 172 may be disposed on the pixel electrode 171 and the bank 190. The light emitting layer 172 may include an organic material to emit light of a predetermined color. For example, the light emitting layer 172 may include a hole transporting layer, an organic material layer, and an electron transporting layer.

The common electrode 173 may be disposed on the light emitting layer 172. The common electrode 173 may be disposed to cover the light emitting layer 172. The common electrode 173 may be a common layer formed in common in the first light emitting portion EA1 and the second light emitting portion EA2.

In the top emission structure, the common electrode 173 may be made of a transparent conductive material (TCO) such as ITO or indium zinc oxide (IZO) capable of transmitting light therethrough or a semi-transmissive conductive material such as magnesium (Mg), silver (Ag), or an alloy of magnesium (Mg) and silver (Ag). When the common electrode 173 is made of the semi-transmissive conductive material, light emission efficiency may be increased by a micro cavity.

A spacer 191 may be disposed on the bank 190. The spacer 191 may serve to support a mask during a manufacturing process of manufacturing the light emitting layer 172. The spacer 191 may be formed as an organic film made of an acrylic resin, an epoxy resin, a phenolic resin, a polyamide resin, a polyimide resin, or the like.

In some embodiments, the display panel 400 may further include a capping layer CPL disposed on the common electrode 173. The capping layer CPL may include an inorganic material. For example, the capping layer CPL may include at least one of silicon nitride, aluminum nitride, zirconium nitride, titanium nitride, hafnium nitride, tantalum nitride, silicon oxide, aluminum oxide, titanium oxide, tin oxide, cerium oxide, and silicon oxynitride.

The encapsulation layer TFEL may be disposed on the common electrode 173. The encapsulation layer TFEL may include at least one inorganic film in order to prevent oxygen or moisture from permeating into the light emitting element layer EML. In addition, the encapsulation layer TFEL may include at least one organic film in order to protect the light emitting element layer EML from foreign substances such as dust. For example, the encapsulation layer TFEL may include a first encapsulation inorganic film TFE1, an encapsulation organic film TFE2, and a second encapsulation inorganic film TFE3.

The first encapsulation inorganic film TFE1 may be disposed on the common electrode 173, the encapsulation organic film TFE2 may be disposed on the first encapsulation inorganic film TFE1, and the second encapsulation inorganic film TFE3 may be disposed on the encapsulation organic film TFE2. Each of the first encapsulation inorganic film TFE1 and the second encapsulation inorganic film TFE3 may be formed as multiple films in which one or more inorganic films of a silicon nitride layer, a silicon oxynitride layer, a silicon oxide layer, a titanium oxide layer, and an aluminum oxide layer are alternately stacked. The encapsulation organic film TFE2 may be an organic film made of an acrylic resin, an epoxy resin, a phenolic resin, a polyamide resin, a polyimide resin, or the like.

The touch sensing layer TDL may be disposed on the encapsulation layer TFEL. The touch sensing layer TDL includes a first touch insulating film TINS1, connection electrodes BE, a second touch insulating film TINS2, driving electrodes TE, sensing electrodes RE, and a third touch insulating film TINS3.

The first touch insulating film TINS1 may be disposed on the encapsulation layer TFEL. The first touch insulating film TINS1 may be formed as an inorganic film such as a silicon nitride layer, a silicon oxynitride layer, a silicon oxide layer, a titanium oxide layer, or an aluminum oxide layer.

The connection electrodes BE may be disposed on the first touch insulating film TINS1. The connection electrode BE may be formed as a single layer or multiple layers made of any one of molybdenum (Mo), aluminum (Al), chromium (Cr), gold (Au), titanium (Ti), nickel (Ni), neodymium (Nd), and copper (Cu), or alloys thereof.

The second touch insulating film TINS2 may be disposed on the connection electrodes BE. The second touch insulating film TINS2 may be formed as an inorganic film such as a silicon nitride layer, a silicon oxynitride layer, a silicon oxide layer, a titanium oxide layer, or an aluminum oxide layer. In an embodiment, the second touch insulating film TINS2 may be formed as an organic film made of an acrylic resin, an epoxy resin, a phenolic resin, a polyamide resin, a polyimide resin, or the like.

The driving electrodes TE and the sensing electrodes RE may be disposed on the second touch insulating film TINS2. Each of the driving electrodes TE and the sensing electrodes RE may be formed as a single layer or multiple layers made of any one of molybdenum (Mo), aluminum (Al), chromium (Cr), gold (Au), titanium (Ti), nickel (Ni), neodymium (Nd), and copper (Cu), or alloys thereof.

The driving electrode TE and the sensing electrode RE may overlap the connection electrodes BE in the third direction DR3. The driving electrode TE may be connected to the connection electrode BE through a touch contact hole TCNT1 penetrating through the second touch insulating film TINS2.

The third touch insulating film TINS3 may be formed on the driving electrodes TE and the sensing electrodes RE. The third touch insulating film TINS3 may serve to planarize a step formed due to the driving electrodes TE, the sensing electrodes RE, and the connection electrodes BE. The third touch insulating film TINS3 may be formed as an organic film made of an acrylic resin, an epoxy resin, a phenolic resin, a polyamide resin, a polyimide resin, or the like.

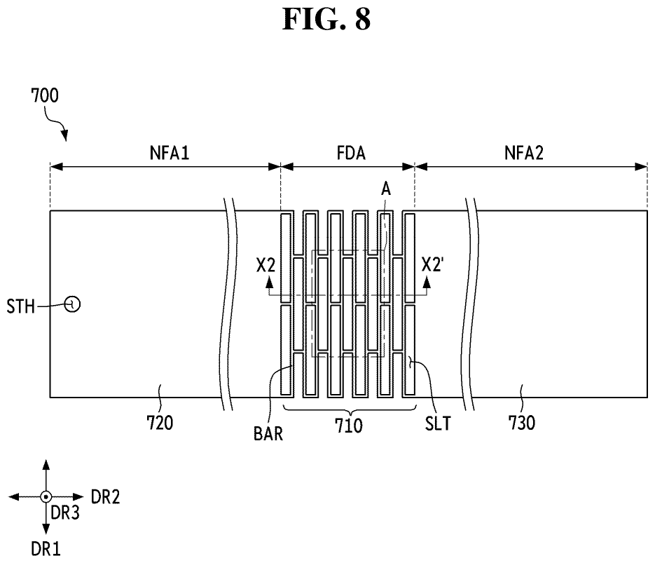

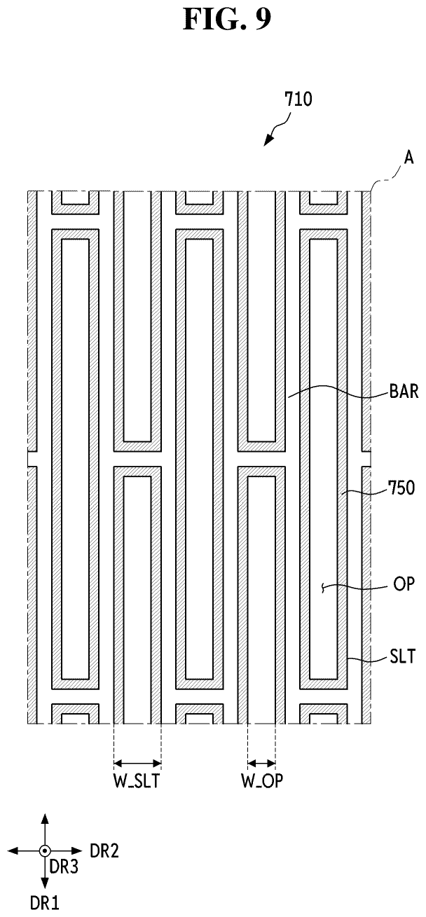

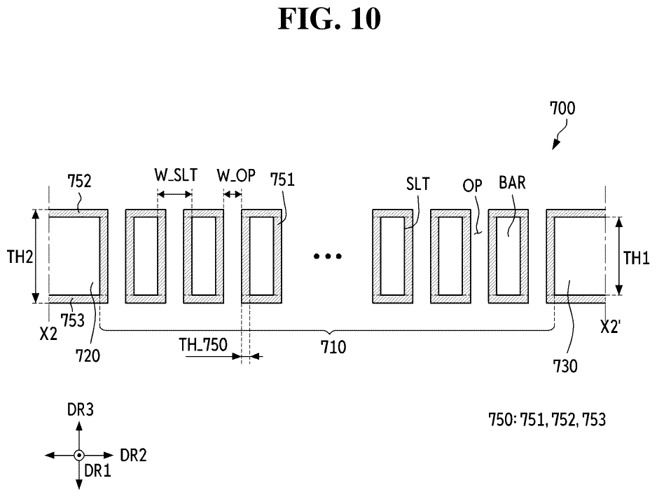

FIG. 8 is a plan view illustrating a panel support member 700 according to an embodiment. FIG. 9 is an enlarged view of area A of FIG. 8. FIG. 10 is a cross-sectional view taken along line X2-X2′ of FIG. 8.

Referring to FIGS. 8 to 10, the panel support member 700 may include a folding portion 710, a first non-folding portion 720, and a second non-folding portion 730. The folding portion 710 may be disposed in the folding area FDA, the first non-folding portion 720 may be disposed in the first non-folding area NFA1, and the second non-folding portion 730 may be disposed in the second non-folding area NFA2.

In some embodiments, the folding area FDA may be an area where the folding portion 710 is disposed, and the first and second non-folding areas NFA1 and NFA2 may be areas where the first and second non-folding portions 720 and 730 are disposed, respectively.

The folding portion 710 may be a portion that is folded when the display device 10 is folded. The folding portion 710 may be disposed between the first non-folding portion 720 and the second non-folding portion 730 in the second direction DR2.

The first non-folding portion 720 and the second non-folding portion 730 may be portions that are not folded when the display device 10 is folded. The first non-folding portion 720 may be disposed on one side of the folding portion 710 in the second direction DR2, and the second non-folding portion 730 may be disposed on the other side of the folding portion 710 in the second direction DR2.

In some embodiments, the through hole STH penetrating through the panel support member 700 may be disposed in the first non-folding portion 720 or the second non-folding portion 730. For example, as illustrated in FIG. 8, the through hole STH may be disposed adjacent to one side of the first non-folding portion 720 in the second direction DR2.

The folding portion 710 may include a grating pattern. For example, the folding portion 710 may include a plurality of bars BAR and a plurality of slits SLT disposed between the plurality of bars BAR.

As illustrated in FIG. 9, the plurality of bars BAR may include a plurality of horizontal bars each extending in the second direction DR2 and a plurality of vertical bars each extending in the first direction DR1. The plurality of bars BAR of the folding portion 710 may be seamlessly connected to each other, and may seamlessly connect the first non-folding portion 720 and the second non-folding portion 730 to each other.

Each of the plurality of slits SLT may be a hole penetrating and passing through the panel support member 700 in the third direction DR3, as illustrated in FIG. 10. Each of the plurality of slits SLT may extend in the first direction DR1, as illustrated in FIG. 9. For example, a length of each of the plurality of slits SLT in the first direction DR1 may be greater than a length of each of the plurality of slits SLT in the second direction DR2. The folding portion 710 may have flexibility by including the plurality of slits SLT. That is, the folding portion 710 may be stretched in the second direction DR2 when the display device 10 is folded.

In the display device 10 according to the present embodiment, the panel support member 700 may further include a plating layer 750. The plating layer 750 may be formed by plating a body of the panel support member 700 (the remaining portion of the panel support member 700 excluding the plating layer 750) with a metal material.

The plating layer 750 may be disposed inside the plurality of slits SLT. For example, the plating layer 750 may be disposed on inner side surfaces of the plurality of slits SLT. As the plating layer 750 is disposed on the inner side surfaces of the plurality of slits SLT, the panel support member 700 may include a plurality of openings OP having a smaller size than the plurality of slits SLT.

A width W_OP of each of the plurality of openings OP may be smaller than a width W_SLT of each of the plurality of slits SLT. Here, the width W_OP of each of the plurality of openings OP and the width W_SLT of each of the plurality of slits SLT refer to lengths of the opening OP and the slit SLT in a short-side direction (e.g., lengths of the opening OP and the slit SLT in the second direction DR2), respectively.

It is illustrated in FIG. 10 that the width W_SLT of each of the plurality of slits SLT is smaller than a thickness TH1 of the panel support member 700 excluding the plating layer 750, but this is only for convenience of illustration, and the present disclosure is not limited thereto. That is, a relationship between the width W_SLT of each of the plurality of slits SLT and the thickness TH1 of the panel support member 700 excluding the plating layer 750 is unrelated to that illustrated in FIG. 10.

In some embodiments, the width W_SLT of each of the plurality of slits SLT may be greater than or equal to the thickness TH1 of the panel support member 700 excluding the plating layer 750. In an embodiment, the width W_SLT of each of the plurality of slits SLT may be greater than or equal to 0.8 times the thickness TH1 of the panel support member 700 excluding the plating layer 750.

The plurality of slits SLT may be formed by processing the body of the panel support member 700 through a wet etching or sand blasting process. A processing process should be sufficiently performed from an upper surface of the panel support member 700 to a lower surface of the panel support member 700 so that the slits SLT penetrating through the panel support member 700 may be formed. Due to characteristics of the processing process, the body of the panel support member 700 is processed in the first direction DR1 and the second direction DR2, which are horizontal directions, as well as a thickness direction (e.g., the third direction DR3) in the processing process, and thus, it is not easy to make the width W_SLT of each of the plurality of slits SLT smaller than the thickness TH1 of the panel support member 700 excluding the plating layer 750.

In some cases, depending on a processing method, it is possible to make the width W_SLT of each of the plurality of slits SLT smaller than the thickness TH1 of the panel support member 700 excluding the plating layer 750, but it is not easy to make the width W_SLT of each of the plurality of slits SLT smaller than 0.8 times the thickness TH1 of the panel support member 700 excluding the plating layer 750. For example, a minimum value of the width W_SLT of each of the plurality of slits SLT may be approximately 80 μm.

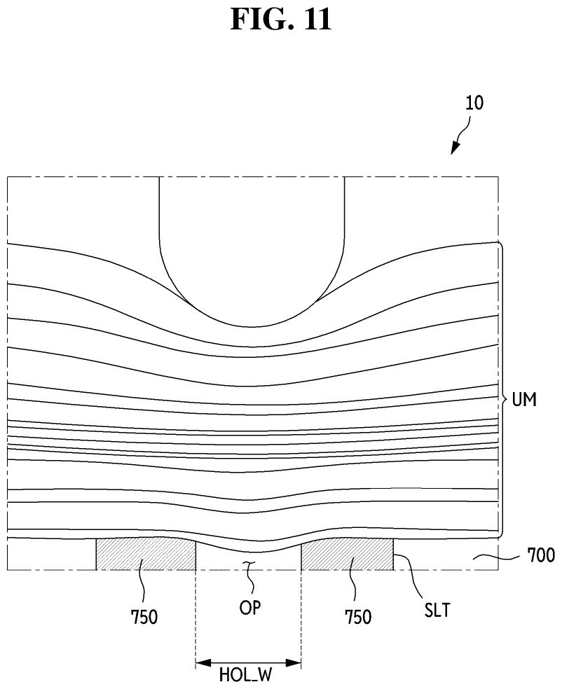

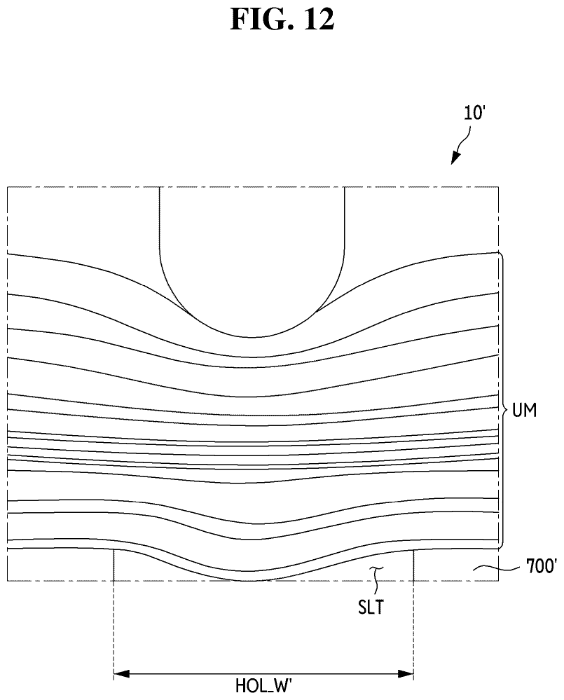

The display device 10 according to the present embodiment includes the plating layer 750, and thus, a width of the hole penetrating through the panel support member 700 may be minimized. For example, the plating layer 750 is disposed on the inner side surfaces of the plurality of slits SLT, and thus, the width of the hole penetrating through the panel support member 700 may be reduced from the width W_SLT of each of the plurality of slits SLT to the width W_OP of each of the plurality of openings OP. That is, in the display device 10 according to the present embodiment, by disposing the plating layer 750 on the inner side surfaces of the plurality of slits SLT instead of reducing the width W_SLT of each of the plurality of slits SLT, it is possible to reduce the width of the hole penetrating through the panel support member 700 to the width W_OP of each of the plurality of openings OP. Accordingly, impact resistance of the display device 10 may be enhanced. The reason why the impact resistance of the display device 10 is enhanced when the width of the hole penetrating through the panel support member 700 is reduced will be described later with reference to FIGS. 11 and 12.

In some embodiments, the plating layer 750 may include a metal material. For example, the plating layer 750 may include at least one of nickel, chromium, copper, zinc, gold, silver, palladium, tin, aluminum, iron, cobalt, and alloys thereof.

The plating layer 750 of the display device 10 according to the present embodiment includes the metal material, and thus, flexural strength of the panel support member 700 may be maintained or increased. For example, the flexural strength of the panel support member 700 may be affected by rigidity of a material of the outermost layer such as the upper and lower surfaces, inner side surfaces, and side surfaces of the panel support member 700. When the plating layer 750 includes such a metal material, the flexural strength of the panel support member 700 may be maintained or increased compared to when the plating layer 750 is not included. In addition, the plating layer 750 may have advantages such as durability, wear resistance, corrosion resistance, heat resistance, and adhesive strength higher than those of a case where a polymer material, an organic material, or the like, is coated.

Although the plating layer 750 is not illustrated on upper surfaces of the plurality of bars BAR for convenience of explanation in FIG. 9, the plating layer 750 may also be disposed on upper and lower surfaces of the plurality of bars BAR, as illustrated in FIG. 10.

For example, the plating layer 750 may include a side surface plating layer 751, an upper surface plating layer 752, and a lower surface plating layer 753. The side surface plating layer 751 may be disposed on the inner side surface of each of the plurality of slits SLT. The upper surface plating layer 752 may be disposed on the upper surface of each of the plurality of bars BAR, an upper surface of the first non-folding portion 720, an upper surface of the second non-folding portion 730, and an upper surface of the side surface plating layer 751. The lower surface plating layer 753 may be disposed on the lower surface of each of the plurality of bars BAR, a lower surface of the first non-folding portion 720, a lower surface of the second non-folding portion 730, and a lower surface of the side surface plating layer 751. The side surface plating layer 751, the upper surface plating layer 752, and the lower surface plating layer 753 may be integrally connected to each other.

It is illustrated in FIG. 10 that the side surface plating layer 751 is a vertical surface extending in the third direction DR3, the upper surface plating layer 752 and the lower surface plating layer 753 are horizontal surfaces perpendicular to the third direction DR3, and a thickness of each of the side surface plating layer 751, the upper surface plating layer 752, and the lower surface plating layer 753 is constant, but the present disclosure is not limited thereto. That is, the thickness of each of the side surface plating layer 751, the upper surface plating layer 752, and the lower surface plating layer 753 may not be constant depending on step coverage. For example, the side surface plating layer 751 may have a thickness that decreases toward a center portion (a center portion of the panel support member 700 in the third direction DR3), and may have a thickness that increases toward edge portions adjacent to the upper surface plating layer 752 and the lower surface plating layer 753.

In some embodiments, a thickness TH_750 of the plating layer 750 may be smaller than half the thickness TH1 of the panel support member 700 excluding the plating layer 750. For example, the thickness TH_750 of the plating layer 750 may be approximately 40 μm or less. Here, the thickness TH_750 of the plating layer 750 refers to a length of the side surface plating layer 751 in the second direction DR2, a length of the upper surface plating layer 752 in the third direction DR3, and a length of the lower surface plating layer 753 in the third direction DR3. In addition, the thickness TH_750 of the plating layer 750 refers to a thickness at a portion where the thickness is the smallest when the thicknesses of the side surface plating layer 751, the upper surface plating layer 752, and the lower surface plating layer 753 are not constant.

In some embodiments, the thickness TH1 of the panel support member 700 excluding the plating layer 750 may be approximately 80 μm to 120 μm. A thickness TH2 of the panel support member 700 including the plating layer 750 may be approximately 100 μm to 150 μm.

In some embodiments, the width W_SLT of each of the plurality of slits SLT may be approximately 60 μm to 150 μm. The width W_OP of each of the plurality of openings OP may be approximately 10 μm to 100 μm. Suitably, the width W_OP of each of the plurality of openings OP may be approximately 50 μm or less.

The display device 10 according to the present embodiment includes the upper surface plating layer 752 and the lower surface plating layer 753, and it is thus possible to reduce the thickness TH1 of the panel support member 700 excluding the plating layer 750. Accordingly, it is also possible to reduce the width W_SLT of each of the plurality of slits SLT.

For example, an entire thickness of the panel support member 700 may have a predetermined range so that it is not excessively small or excessively great, in consideration of a degree of rigidity for supporting the display panel 400, foldability of the display device 10, and the like. An example of a value of the entire thickness of the panel support member 700 may be approximately 100 μm to 150 μm like the thickness TH2 of the panel support member 700 including the plating layer 750 described above.

The display device 10 according to the present embodiment includes the upper surface plating layer 752 and the lower surface plating layer 753, and it is thus possible to reduce the thickness TH1 of the panel support member 700 excluding the plating layer 750 while maintaining the entire thickness of the panel support member 700. An example of a value of the thickness TH1 of the panel support member 700 excluding the plating layer 750 may be approximately 80 μm to 120 μm, as described above.

When the thickness TH1 of the panel support member 700 excluding the plating layer 750 is reduced as described above, the width W_SLT of each of the plurality of slits SLT may also be reduced in a processing process of the slit SLT. Accordingly, separately from the reduction in the width of the hole penetrating through the panel support member 700 due to the side surface plating layer 751, by disposing the upper surface plating layer 752 and the lower surface plating layer 753, the thickness TH1 of the panel support member 700 excluding the plating layer 750 is reduced, such that the width W_SLT of each of the plurality of slits SLT may be reduced, and for this reason, the width of the hole penetrating through the panel support member 700 may be further reduced.

Since the plating layer 750 includes the metal material, even though a difference between the thickness TH1 of the panel support member 700 excluding the plating layer 750 and the thickness TH2 of the panel support member 700 including the plating layer 750 is replaced with the plating layer 750, physical properties of the panel support member 700, such as rigidity and an elastic modulus, may be maintained at a similar level.

FIG. 11 is a cross-sectional view illustrating an impact resistance test of the display device 10 according to an embodiment. FIG. 12 is a cross-sectional view illustrating an impact resistance test of a display device 10′ according to a comparative example.

Referring to FIGS. 11 and 12 in addition to FIG. 6 and FIGS. 8 to 10, the display device 10 according to an embodiment may include the panel support member 700 and an upper member UM disposed above the panel support member 700. A display device 10′ according to a comparative example may include a panel support member 700′ and an upper member UM disposed above the panel support member 700′.

The upper member UM of each of the display devices 10 and 10′ according to an embodiment and a comparative example may include the cover window CCW, the upper protection member 100, the window member 200, the first adhesive member 300, the display panel 400, the panel protection member 500, and the panel lower member 600 as illustrated in FIG. 6.

The panel support member 700 of the display device 10 according to an embodiment is substantially the same as the panel support member 700 described with reference to FIGS. 8 to 10. The panel support member 700′ of the display device 10′ according to a comparative example is different from the panel support member 700 described with reference to FIGS. 8 to 10 in that it does not include the plating layer 750.

FIGS. 11 and 12 illustrate states in which an impact resistance test according to a pen drop is performed on the display devices 10 and 10′ according to an embodiment and a comparative example, respectively.

As illustrated in FIG. 12, the display device 10′ according to a comparative example does not include the plating layer 750, and thus, a width HOL_W′ of a hole penetrating through the panel support member 700 is relatively great, such that deformation applied to the upper member UM due to impact caused by the pen drop may be great.

As illustrated in FIG. 11, the display device 10 according to an embodiment includes the plating layer 750, and thus, a width HOL_W of a hole penetrating through the panel support member 700 is relatively small, such that deformation applied to the upper member UM due to impact caused by the pen drop may be small.

For example, strain of the upper member UM in the display device 10′ according to a comparative example may be two times or more the strain of the upper member UM in the display device 10 according to an embodiment. Accordingly, a bright spot may occur in the display panel 400 included in the upper member UM in the display device 10′ according to a comparative example, whereas a bright spot may not occur in the display panel 400 included in the upper member UM in the display device 10 according to an embodiment.

As described above, the display device 10 according to the present embodiment includes the plating layer 750, and thus, the width HOL_W of the hole penetrating through the panel support member 700 may be reduced, such that the impact resistance of the display device 10 may be enhanced. For example, in the display device 10 according to the present embodiment, the width HOL_W of the hole penetrating through the panel support member 700 may be defined as a width of the opening OP, and the width of the opening OP may be approximately 50 μm or less. When the width of the opening OP is approximately 50 μm or less, the strain of the upper member UM is reduced, such that the impact resistance of the display device 10 may be enhanced.

Hereinafter, other embodiments of the display device according to an embodiment will be described. In the following embodiments, the same components as those of the above-described embodiment will be denoted by the same reference numerals, and an overlapping description thereof will be omitted or simplified and contents different from those described above will be mainly described.

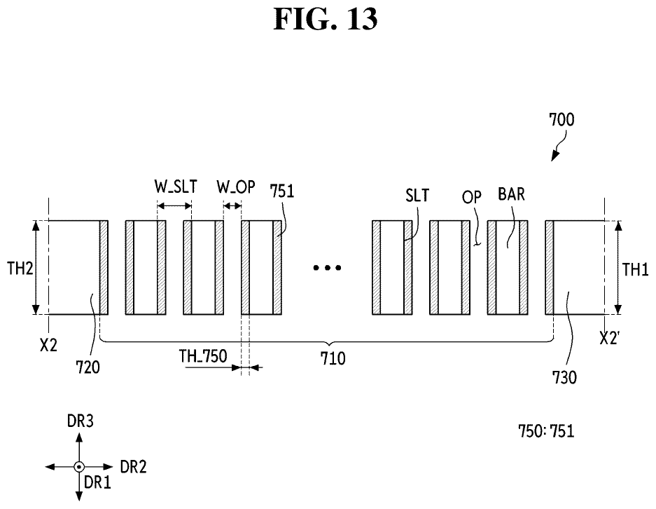

FIG. 13 is a cross-sectional view illustrating a panel support member 700 according to an embodiment.

Referring to FIG. 13, a display device 10 according to the present embodiment is different from the display device 10 according to an embodiment described with reference to FIG. 10 or the like in that it does not include the upper surface plating layer 752 and the lower surface plating layer 753.

More specifically, in the display device 10 according to the present embodiment, the plating layer 750 may be disposed inside the plurality of slits SLT, similar to the display device 10 according to an embodiment described with reference to FIG. 10 or the like. For example, the plating layer 750 may be disposed on inner side surfaces of the plurality of slits SLT. As the plating layer 750 is disposed on the inner side surfaces of the plurality of slits SLT, the panel support member 700 may include a plurality of openings OP having a smaller size than the plurality of slits SLT. A width W_OP of each of the plurality of openings OP may be smaller than a width W_SLT of each of the plurality of slits SLT.

However, in the display device 10 according to the present embodiment, the plating layer 750 may include only the side surface plating layer 751. For example, in the display device 10 according to the present embodiment, the plating layer 750 may not include the upper surface plating layer 752 and the lower surface plating layer 753 according to an embodiment described with reference to FIG. 10 or the like.

The plating layer 750 may include only the side surface plating layer 751 and thus, may be disposed on the inner side surfaces of the plurality of slits SLT but may not be disposed on the upper and lower surfaces of each of the plurality of bars BAR, the upper and lower surfaces of the first non-folding portion 720, the upper and lower surfaces of the second non-folding portion 730, and the upper and lower surfaces of the side surface plating layer 751.

The plating layer 750 of the panel support member 700 according to the present embodiment may be formed by masking the upper and lower surfaces of each of the plurality of bars BAR, the upper and lower surfaces of the first non-folding portion 720, and the upper and lower surfaces of the second non-folding portion 730.

The display device 10 according to the present embodiment does not include the upper surface plating layer 752 and the lower surface plating layer 753, and thus, the thickness TH1 of the panel support member 700 excluding the plating layer 750 may be the same as the thickness TH2 of the panel support member 700 including the plating layer 750. That is, the entire thickness of the panel support member 700 may be the same regardless of whether or not it includes the thickness TH_750 of the plating layer 750.

Accordingly, in the display device 10 according to the present embodiment, the thickness of the panel support member 700 may be kept constant regardless of the thickness TH_750 of the plating layer 750, and thus, an influence of rigidity and other physical properties of the panel support member 700 according to a yield of a plating process may be minimized.

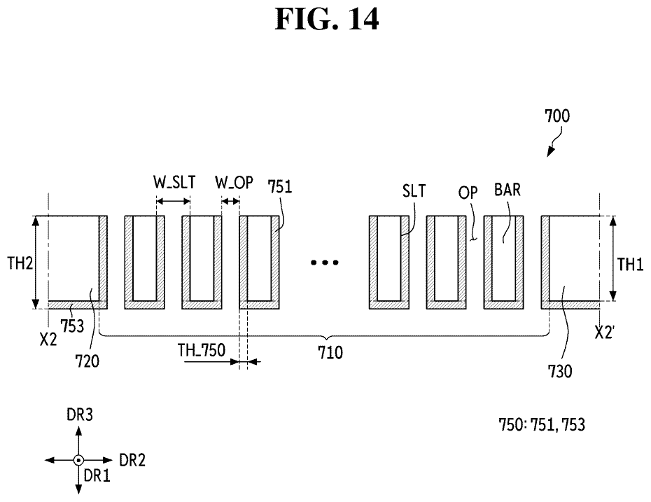

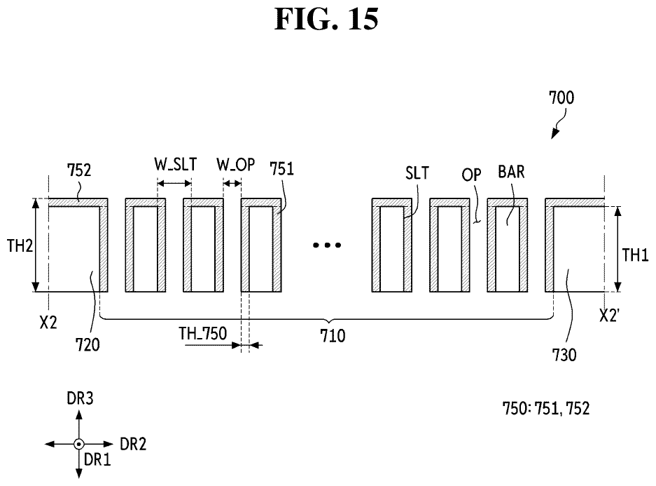

FIG. 14 is a cross-sectional view illustrating a panel support member 700 according to an embodiment. FIG. 15 is a cross-sectional view illustrating a panel support member 700 according to an embodiment.

Referring to FIGS. 14 and 15, a display device 10 according to the present embodiment is different from the display device 10 according to an embodiment described with reference to FIG. 10 or the like in that it does not include any one of the upper surface plating layer 752 and the lower surface plating layer 753.

More specifically, in the display device 10 according to the present embodiment, the plating layer 750 may be disposed inside the plurality of slits SLT, similar to the display device 10 according to an embodiment described with reference to FIG. 10 or the like. For example, the plating layer 750 may be disposed on inner side surfaces of the plurality of slits SLT. As the plating layer 750 is disposed on the inner side surfaces of the plurality of slits SLT, the panel support member 700 may include a plurality of openings OP having a smaller size than the plurality of slits SLT. A width W_OP of each of the plurality of openings OP may be smaller than a width W_SLT of each of the plurality of slits SLT.

However, in the display device 10 according to the present embodiment, the plating layer 750 may include only any one of the upper surface plating layer 752 and the lower surface plating layer 753 in addition to the side surface plating layer 751.

In an embodiment, as illustrated in FIG. 14, in the display device 10 according to the present embodiment, the plating layer 750 may not include the upper surface plating layer 752 and may include the lower surface plating layer 753. In this case, the plating layer 750 may include the side surface plating layer 751 and the lower surface plating layer 753 and thus, may be disposed on the inner side surfaces of the plurality of slits SLT, the lower surface of each of the plurality of bars BAR, the lower surface of the first non-folding portion 720, the lower surface of the second non-folding portion 730, and the lower surface of the side surface plating layer 751 but may not be disposed on the upper surface of each of the plurality of bars BAR, the upper surface of the first non-folding portion 720, the upper surface of the second non-folding portion 730, and the upper surface of the side surface plating layer 751.

The plating layer 750 of the panel support member 700 according to an embodiment of FIG. 14 may be formed by masking the upper surface of each of the plurality of bars BAR, the upper surface of the first non-folding portion 720, and the upper surface of the second non-folding portion 730.

In an embodiment, as illustrated in FIG. 15, in the display device 10 according to the present embodiment, the plating layer 750 may not include the lower surface plating layer 753 and may include the upper surface plating layer 752. In this case, the plating layer 750 may include the side surface plating layer 751 and the upper surface plating layer 752 and thus, may be disposed on the inner side surfaces of the plurality of slits SLT, the upper surface of each of the plurality of bars BAR, the upper surface of the first non-folding portion 720, the upper surface of the second non-folding portion 730, and the upper surface of the side surface plating layer 751 but may not be disposed on the lower surface of each of the plurality of bars BAR, the lower surface of the first non-folding portion 720, the lower surface of the second non-folding portion 730, and the lower surface of the side surface plating layer 751.

The plating layer 750 of the panel support member 700 according to an embodiment of FIG. 15 may be formed by masking the lower surface of each of the plurality of bars BAR, the lower surface of the first non-folding portion 720, and the lower surface of the second non-folding portion 730.

The display devices 10 according to the present embodiments include only any one of the upper surface plating layer 752 and the lower surface plating layer 753, and thus, the thickness TH1 of the panel support member 700 excluding the plating layer 750 may be smaller than the thickness TH2 of the panel support member 700 including the plating layer 750 by the thickness TH_750 of the plating layer 750.

Accordingly, in the display devices 10 according to the present embodiments, by adjusting the thickness TH_750 of the plating layer 750, it is possible to adjust the thickness of the panel support member 700 and it is possible to adjust rigidity and other properties of the panel support member 700 according to the thickness of the panel support member 700.

In addition, with the display devices 10 according to the present embodiments, any one of the upper surface plating layer 752 and the lower surface plating layer 753 may be omitted in consideration of a relationship with another member disposed on the upper surface or the lower surface of the panel support member 700, adhesive strength of an adhesive member, or the like.

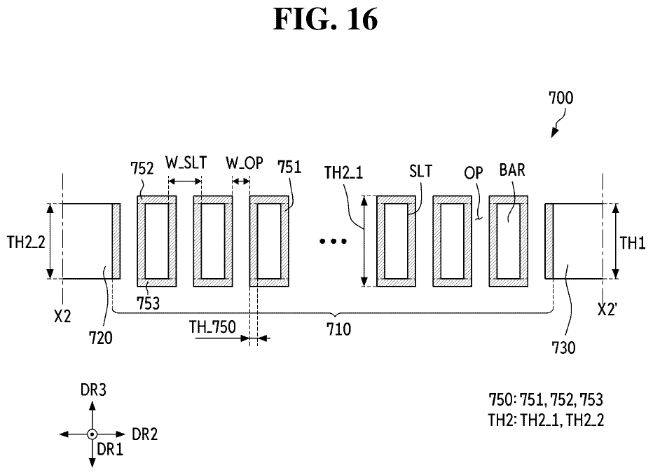

FIG. 16 is a cross-sectional view illustrating a panel support member 700 according to an embodiment.

Referring to FIG. 16, a display device 10 according to the present embodiment is different from the display device 10 according to an embodiment described with reference to FIG. 10 or the like in that the upper surface plating layer 752 and the lower surface plating layer 753 are not disposed on the non-folding portions 720 and 730.

More specifically, in the display device 10 according to the present embodiment, the plating layer 750 may be disposed inside the plurality of slits SLT, similar to the display device 10 according to an embodiment described with reference to FIG. 10 or the like. For example, the plating layer 750 may be disposed on inner side surfaces of the plurality of slits SLT. As the plating layer 750 is disposed on the inner side surfaces of the plurality of slits SLT, the panel support member 700 may include a plurality of openings OP having a smaller size than the plurality of slits SLT. A width W_OP of each of the plurality of openings OP may be smaller than a width W_SLT of each of the plurality of slits SLT.

However, in the display device 10 according to the present embodiment, a disposition of the plating layer 750 in the non-folding portions 720 and 730 and a disposition of the plating layer 750 in the folding portion 710 may be different from each other. For example, the upper surface plating layer 752 and the lower surface plating layer 753 may be disposed on the folding portion 710, and may not be disposed on the non-folding portions 720 and 730.

The side surface plating layer 751 may overlap the folding portion 710 in the third direction DR3, and may not overlap the non-folding portions 720 and 730 in the third direction DR3. Each of the upper surface plating layer 752 and the lower surface plating layer 753 may overlap the folding portion 710 in the third direction DR3, and may not overlap the non-folding portions 720 and 730 in the third direction DR3.

The upper surface plating layer 752 may be disposed on the upper surface of each of the plurality of bars BAR, and the lower surface plating layer 753 may be disposed on the lower surface of each of the plurality of bars BAR. The upper surface plating layer 752 may not be disposed on the upper surface of the first non-folding portion 720 and the upper surface of the second non-folding portion 730, and the lower surface plating layer 753 may not be disposed on the lower surface of the first non-folding portion 720 and the lower surface of the second non-folding portion 730.

The upper surface plating layer 752 may be disposed on upper surfaces of the side surface plating layers 751 disposed on both sides of each of the plurality of bars BAR, and may not be disposed on upper surfaces of the side surface plating layers 751 adjacent to the first non-folding portion 720 and the second non-folding portion 730. The lower surface plating layer 753 may be disposed on lower surfaces of the side surface plating layers 751 disposed on both sides of each of the plurality of bars BAR, and may not be disposed on lower surfaces of the side surface plating layers 751 adjacent to the first non-folding portion 720 and the second non-folding portion 730.

The plating layer 750 of the panel support member 700 according to the present embodiment may be formed by masking the upper and lower surfaces of the first non-folding portion 720 and the upper and lower surfaces of the second non-folding portion 730.

In the display device 10 according to the present embodiment, the disposition of the plating layer 750 in the non-folding portions 720 and 730 and the disposition of the plating layer 550 in the folding portion 710 are different from each other, and thus, a thickness of the panel support member 700 in the non-folding portions 720 and 730 and a thickness of the panel support member 700 in the folding portion 710 may be different from each other. For example, the thickness TH1 of the panel support member 700 excluding the plating layer 750 in the non-folding portions 720 and 730 and the thickness TH1 of the panel support member 700 excluding the plating layer 750 in the folding portion 710 may be the same as each other.

In an embodiment, the thickness TH2 of the panel support member 700 including the plating layer 750 in the non-folding portions 720 and 730 and the thickness TH2 of the panel support member 700 including the plating layer 750 in the folding portion 710 may be different from each other. For example, a thickness TH2_1 of the panel support member 700 including the plating layer 750 in an area overlapping the folding portion 710 may be greater than the thickness TH1 of the panel support member 700 excluding the plating layer 750 by the thickness TH_750 of the plating layer 750 (e.g., two times the thickness TH_750 of the plating layer 750). A thickness TH2_2 of the panel support member 700 including the plating layer 750 in areas overlapping the non-folding portions 720 and 730 may be the same as the thickness TH1 of the panel support member 700 excluding the plating layer 750. That is, the entire thickness of the panel support member 700 in the areas overlapping the non-folding portions 720 and 730 may be the same regardless of whether or not it includes the thickness TH_750 of the plating layer 750.

In the display device 10 according to the present embodiment, by making the disposition of the plating layer 750 in the non-folding portions 720 and 730 and the disposition of the plating layer 750 in the folding portion 710 different from each other, it is possible to balance impact resistance in the non-folding portions 720 and 730 and the folding portion 710. For example, when the plating layer 750 is not included, the folding portion 710 may have lower impact resistance than the non-folding portions 720 and 730. Accordingly, by disposing the upper surface plating layer 752 and the lower surface plating layer 753 only on the folding portion 710 having relatively lower impact resistance, it is possible to balance the impact resistance in the folding portion 710 and the non-folding portions 720 and 730.

In concluding the detailed description, those skilled in the art will appreciate that many variations and modifications can be made to the embodiments without substantially departing from the principles of the present disclosure. Therefore, the disclosed embodiments of the inventive concept are used in a generic and descriptive sense only and not for purposes of limitation.

What is claimed is:

1. A display device comprising:
a display panel; and
a panel support member disposed on the display panel and including a folding portion and a non-folding portion disposed on at least one side of the folding portion,
wherein the folding portion includes a plurality of slits penetrating through the panel support member and a plurality of bars disposed alternately with the plurality of slits,
wherein the panel support member further includes a plating layer covering at least a portion of the folding portion and including a metal material, and
wherein the plating layer is disposed on inner side surfaces of the plurality of slits.

2. The display device of claim 1, wherein the metal material of the plating layer includes at least one of nickel, chromium, copper, zinc, gold, silver, palladium, tin, aluminum, iron, cobalt, and alloys thereof.

3. The display device of claim 1, wherein a width of a slit of the plurality of slits is greater than or equal to a thickness of the panel support member excluding the plating layer.

4. The display device of claim 1, wherein the plating layer includes a first side surface plating layer disposed on one side of a slit of the plurality of slits and a second side surface plating layer disposed on another side of the slit,
wherein the panel support member includes an opening disposed in a space between the first side surface plating layer and the second side surface plating layer, and
a width of the opening is smaller than a width of the slit.

5. The display device of claim 4, wherein the width of the opening is 50 μm or less.

6. The display device of claim 1, wherein a thickness of the plating layer is smaller than half of a thickness of the panel support member excluding the plating layer.

7. The display device of claim 6, wherein the thickness of the plating layer is 40 μm or less.

8. The display device of claim 1, wherein the plating layer is further disposed on at least one of an upper surface and a lower surface of the panel support member.

9. The display device of claim 8, wherein the plating layer includes side surface plating layers disposed on inner side surfaces of the plurality of slits, and
wherein the plating layer further includes at least one of an upper surface plating layer disposed on the upper surface of the panel support member and a lower surface plating layer disposed on the lower surface of the panel support member.

10. The display device of claim 9, wherein the upper surface plating layer is disposed on the folding portion and is not disposed on the non-folding portion.

11. The display device of claim 1, wherein the panel support member includes a metal plate or a fiber polymer.

12. A display device comprising:
a display panel; and
a panel support member disposed on the display panel and including a folding portion and a non-folding portion disposed on at least one side of the folding portion,
wherein the folding portion includes a plurality of slits penetrating through the panel support member and a plurality of bars disposed alternately with the plurality of slits,
wherein the panel support member further includes a plating layer covering at least a portion of the folding portion, and
wherein the plating layer includes side surface plating layers disposed on inner side surfaces of the plurality of slits.

13. The display device of claim 12, wherein the plating layer further includes an upper surface plating layer disposed on an upper surface of the panel support member and a lower surface plating layer disposed on a lower surface of the panel support member, and
wherein each of the upper surface plating layer and the lower surface plating layer is disposed on the plurality of bars.

14. The display device of claim 13, wherein the upper surface plating layer and the lower surface plating layer are not disposed on the non-folding portion.

15. The display device of claim 14, wherein a thickness of the panel support member in an area overlapping the folding portion is greater than a thickness of the panel support member in an area overlapping the non-folding portion.

16. The display device of claim 13, wherein at least one of the upper surface plating layer and the lower surface plating layer is further disposed on the non-folding portion.

17. The display device of claim 12, wherein a thickness of the plating layer is smaller than half a thickness of the panel support member excluding the plating layer.

18. The display device of claim 12, wherein the plating layer includes a metal material.

19. The display device of claim 12, wherein the panel support member includes a metal plate or a fiber polymer.

20. A foldable electronic device comprising a display device,
wherein the display device includes:
a display panel;
a window member disposed above the display panel;
an upper protection member disposed on the window member;
a cover window disposed on the upper protection member;
a panel protection member disposed below the display panel; and
a panel support member disposed below the panel protection member and including a folding portion and a non-folding portion disposed on at least one side of the folding portion,
wherein the folding portion includes a plurality of slits penetrating through the panel support member and a plurality of bars disposed alternately with the plurality of slits,
wherein the panel support member further includes a plating layer covering at least a portion of the folding portion and including a metal material, and
wherein the plating layer is disposed on inner side surfaces of the plurality of slits.
